(19) United States
(12) Patent Application Publication
(10) Pub. No.: US 2025/0336915 A1
(43) Pub. Date: Oct. 30, 2025

(54) POSITIVE ELECTRODE PLATE AND NON-AQUEOUS ELECTROLYTE SECONDARY BATTERY

(71) Applicant: Prime Planet Energy & Solutions, Inc., Tokyo (JP)

(72) Inventors: Kouhei MASAI, Kobe-shi (JP); Ryo HANAZAKI, Kobe-shi (JP)

(21) Appl. No.: 19/183,923

(22) Filed: Apr. 21, 2025

(30) Foreign Application Priority Data
Apr. 24, 2024 (JP) 2024-070254

(51) Int. Cl. H01M 4/131; H01M 4/02

(52) U.S. Cl. CPC H01M 4/131; H01M 2004/021; H01M 2004/028

(57) ABSTRACT

The present disclosure relates to a positive electrode plate, in which a first active material layer has a depressed structure in which a plurality of depressions are formed on a side facing the second active material layer; a second active material layer has a protruded structure in which a plurality of protrusions are formed on a side facing the first active material layer; in a cross section in a thickness direction of the positive electrode active material layer, an interface at which the first active material layer and the second active material layer are in contact with each other has an uneven shape formed by a combination of the plurality of depressions and the plurality of protrusions; and a mass ratio of the second active material layer to the first active material layer in the positive electrode active material layer is from 1/9 to 3/7.

### CROSS REFERENCE TO RELATED APPLICATIONS

This nonprovisional application is based on Japanese Patent Application No. 2024-070254 filed on Apr. 24, 2024, with the Japan Patent Office, the entire contents of which are hereby incorporated by reference.

### BACKGROUND OF THE INVENTION

### Field of the Invention

The present disclosure relates to a positive electrode plate, and it also relates to a non-aqueous electrolyte secondary battery comprising the positive electrode plate.

### Description of the Background Art

Japanese Patent Laying-Open No. 2022-63677 discloses a positive electrode comprising a positive electrode active material, wherein the positive electrode active material comprises a first layer including single particles and a second layer including secondary particles each consisting of primary particles aggregated together, and the second layer is interposed between the first layer and a positive electrode base material.

### SUMMARY OF THE INVENTION

In the positive electrode plate described in Japanese Patent Laying-Open No. 2022-63677, only the same type of active material is present in the long-side direction of the positive electrode active material layer (the direction parallel to the plane), so in the first layer in which single particles (which have high resistance as compared to aggregated particles) are in contact with each other, resistance tends not to be low enough. As a result, input-output resistance of the non-aqueous electrolyte secondary battery may not be low enough, so there is a demand for further reducing the input-output resistance.

An object of the present disclosure is to provide a positive electrode plate that has a positive electrode current collector, a first active material layer including aggregated particles, and a second active material layer including single particles in this order, and that is capable of reducing input-output resistance of the non-aqueous electrolyte secondary battery.

[1] A positive electrode plate comprising:
a positive electrode current collector; and
a positive electrode active material layer provided on the positive electrode current collector, wherein
the positive electrode active material layer includes a first active material layer and a second active material layer,
the first active material layer is positioned closer to the positive electrode current collector,
the second active material layer is positioned in contact with the first active material layer and on a side of the first active material layer opposite to the positive electrode current collector,
the first active material layer includes secondary particles each consisting of primary particles aggregated together,
the second active material layer includes single particles,
the first active material layer has a depressed structure in which a plurality of depressions are formed on a side facing the second active material layer,
the second active material layer has a protruded structure in which a plurality of protrusions are formed on a side facing the first active material layer,
in a cross section in a thickness direction of the positive electrode active material layer passing through the plurality of depressions and the plurality of protrusions, an interface at which the first active material layer and the second active material layer are in contact with each other has an uneven shape formed by a combination of the plurality of depressions and the plurality of protrusions, and
a mass ratio of the second active material layer to the first active material layer in the positive electrode active material layer is from 1/9 to 3/7.

[2] The positive electrode plate according to [1], wherein a ratio of C to D (C/D) satisfies an expression (1) below:

$$C / D \leq 3.0 \qquad ( 1 )$$

where a depth of the depressions is defined as C, and a thickness of the second active material layer on a part of the first active material layer without the depressions is defined as D.

[3] The positive electrode plate according to [1] or [2], wherein a ratio of a total of C and D to T [(C+D)/T] satisfies an expression (2) below:

$$( C + D ) / T < 0.5 \qquad ( 2 )$$

where a thickness of the positive electrode active material layer is defined as T, a depth of the depressions is defined as C, and a thickness of the second active material layer on a part of the first active material layer without the depressions is defined as D.

[4] The positive electrode plate according to any one of [1] to [3], wherein a ratio of B to A (B/A) satisfies an expression (3) below:

$$2 \leq B / A \qquad ( 3 )$$

where a width of the protrusions is defined as A, and a distance between the protrusions is defined as B.

[5] The positive electrode plate according to any one of [1] to [4], wherein a ratio of A to R₂ (A/R₂) satisfies an expression (4) below:

$$A / {R}_{2} \leq 6. \qquad ( 4 )$$

where a width of the protrusions is defined as A, and an average particle size of the single particles is defined as R₂.

[6] A non-aqueous electrolyte secondary battery comprising the positive electrode plate according to any one of [1] to [5].

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic cross-sectional view illustrating a positive electrode plate according to the present disclosure.

### DESCRIPTION OF THE PREFERRED EMBODIMENTS

### <Positive Electrode Plate>

A positive electrode plate according to the present disclosure includes a positive electrode current collector, and a positive electrode active material layer provided on the positive electrode current collector. The positive electrode active material layer includes a first active material layer and a second active material layer. The first active material layer is positioned closer to the positive electrode current collector. The second active material layer is positioned in contact with the first active material layer and on a side of the first active material layer opposite to the positive electrode current collector. The first active material layer includes secondary particles each consisting of primary particles aggregated together. The second active material layer includes single particles. The first active material layer has a depressed structure in which a plurality of depressions are formed on a side facing the second active material layer. The second active material layer has a protruded structure in which a plurality of protrusions are formed on a side facing the first active material layer. In a cross section in a thickness direction of the positive electrode active material layer passing through the plurality of depressions and the plurality of protrusions, the shape of the interface (hereinafter also called an interface shape) at which the first active material layer and the second active material layer are in contact with each other is an uneven shape formed by a combination of the plurality of depressions and the plurality of protrusions. A mass ratio of the second active material layer to the first active material layer is from 9:1 to 7:3.

The positive electrode plate according to the present disclosure has an uneven interface shape with depressions and protrusions, where the first active material layer has a depressed structure in which a plurality of depressions are formed on a side facing the second active material layer and the second active material layer has a protruded structure in which a plurality of protrusions are formed on a side facing the first active material layer, and, thereby, single particles in the protrusions with high resistance are surrounded by aggregated particles in the depressions with low resistance. As a result, the single particles with relatively high resistance can come into contact with the aggregated particles with relatively low resistance, and thereby the resistance of the second active material layer including the single particles tends to be reduced. Even when the interface shape is uneven, the cycle life of the battery will not be degraded.

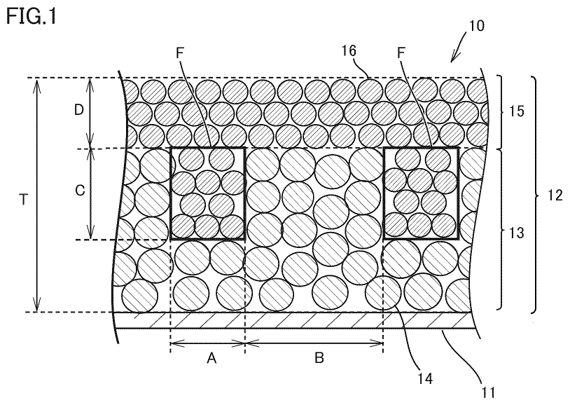

FIG. 1 is a schematic cross-sectional view illustrating a positive electrode plate. A positive electrode plate 10 includes a positive electrode current collector 11 and a positive electrode active material layer 12. Positive electrode plate 10 may be a belt-shaped sheet having a long-side direction and a short-side direction, and may be a sheet that is rectangular when viewed in the thickness direction (hereinafter also called a plan view) (for example, an oblong sheet having a long-side direction and a short-side direction). Positive electrode active material layer 12 includes a first active material layer 13 and a second active material layer 15.

Positive electrode current collector 11 is a conductive sheet. Positive electrode current collector 11 may have a thickness from 10 μm to 30 μm, for example. Positive electrode current collector 11 may include an Al foil sheet and/or the like, for example.

The thickness T of positive electrode active material layer 12 can be from 10 μm to 200 μm, for example. The thickness T of positive electrode active material layer 12 can be from 50 μm to 150 μm, for example. The thickness T of positive electrode active material layer 12 can be from 50 μm to 100 μm, for example.

First active material layer 13 is positioned closer to positive electrode current collector 11 than second active material layer 15 is. First active material layer 13 is a lower layer with respect to second active material layer 15. First active material layer 13 is interposed between second active material layer 15 and positive electrode current collector 11. First active material layer 13 may be in contact with positive electrode current collector 11, for example. First active material layer 13 may be formed on a surface of positive electrode current collector 11, for example. First active material layer 13 includes a first particle group as a main positive electrode active material. The mass fraction of the first particle group relative to all the positive electrode active materials in first active material layer 13 may be from 95% to 100%, or may be from 99% to 100, or may be 100%, for example.

The first particle group includes a plurality of aggregated particles 14. Aggregated particles 14 are a positive electrode active material. The first particle group may consist essentially of aggregated particles 14, for example. The first particle group may consist of aggregated particles 14, for example. Aggregated particles 14 may have any shape. Aggregated particles 14 may be spherical, columnar, in lumps, and/or the like, for example. The average particle size R₁ of the plurality of aggregated particles 14 may be from 7 μm to 20 μm, or may be from 8 μm to 16 μm, for example. The average particle size R₁ may be greater than an average particle size R₂. Each of the average particle size R₁ and the average particle size R₂ is a particle size D50 in volume-based particle size distribution at which cumulative frequency of particle sizes accumulated from the small size side reaches 50%. The average particle size R₁ and the average particle size R₂ can be measured by a measurement method described below in the Examples section.

Each aggregated particle 14 is formed of 50 or more primary particles aggregated together. The primary particles included in each aggregated particle 14 tends to have a low resistance against Li-ion diffusion.

The number of primary particles included in each aggregated particle 14 is measured in an SEM image of the aggregated particle 14. The magnification of the SEM image may be from 10000 times to 30000 times, for example. Each aggregated particle 14 may be formed of at least 100 primary particles aggregated together, for example. The upper limit to the number of primary particles in each aggregated particle 14 is not defined. Each aggregated particle 14 may be formed of 10000 or less primary particles aggregated together, for example. Each aggregated particle 14 may be formed of 1000 or less primary particles aggregated together, for example. The primary particles may have any shape. The primary particles may be spherical, columnar, in lumps, and/or the like, for example.

The primary particle refers to a particle whose grain boundary is not visually identified in an SEM image of the particle. The primary particle has a first largest diameter. The first largest diameter refers to the distance between two points located farthest apart from each other on the outline of the primary particle. The primary particle may have a first largest diameter less than 0.5 μm, for example. The primary particle may have a first largest diameter from 0.05 μm to 0.2 μm, for example. When each of 10 or more primary particles randomly selected in an SEM image of one aggregated particle has a first largest diameter from 0.05 μm to 0.2 μm, it may be regarded that each of all the primary particles included in the aggregated particle has a first largest diameter from 0.05 μm to 0.2 μm. Each primary particle may have a first largest diameter from 0.1 μm to 0.2 μm, for example. The average value of the first largest diameter may be from 0.1 μm to 0.2 μm, for example. The average value is the arithmetic mean of 100 or more primary particles. These 100 or more primary particles are randomly selected.

Second active material layer 15 is positioned in contact with first active material layer 13 and on a side of first active material layer 13 opposite to positive electrode current collector 11. Second active material layer 15 is an upper layer with respect to first active material layer 13. Second active material layer 15 may constitute a surface of positive electrode active material layer 12, for example. Second active material layer 15 includes a second particle group as a main positive electrode active material. The mass fraction of the second particle group relative to all the positive electrode active materials in second active material layer 15 may be from 95% to 100%, or may be from 99% to 100%, or may be 100%, for example.

The second particle group includes a plurality of single particles 16. Single particles 16 is a positive electrode active material. The second particle group may consist essentially of single particles 16, for example. The second particle group may consist of single particles 16, for example. Single particles 16 may have any shape. Single particles 16 may be spherical, columnar, in lumps, and/or the like, for example. The average particle size R₂ of single particles 16 may be from 1 μm to 6 μm, for example.

Single particle 16 is a particle that was grown and became larger. Single particle 16 refers to a particle whose grain boundary is not visually identified in an SEM image of the particle. Because of the relatively less grain boundaries, the single particles tend not to become cracked as compared to the aggregated particles. In the second particle group, single particles 16 may be included as lone single particles, or may be included as an aggregate of two to ten single particles.

Aggregated particle 14 and single particle 16 may independently have any crystal structure. Single particle 16 and aggregated particle 14 may independently have a layered structure, a spinel structure, an olivine structure, and/or the like, for example.

Aggregated particle 14 and single particle 16 may independently have any composition. The composition of single particle 16 may be the same as that of aggregated particle 14, for example. The composition of aggregated particle 14 may be different from that of single particle 16, for example. Aggregated particle 14 and single particle 16 may independently include at least one selected from the group consisting of LiNiO₂, Li(NiCoMn)O₂, and Li(NiCoAl)O₂, for example. Here, the expression “(NiCoMn)” in the composition formula “Li(NiCoMn)O₂”, for example, means that the constituents within the parentheses are regarded as collectively taking up one fraction in the entire composition ratio.

Aggregated particle 14 and single particle 16 may independently include a layered metal oxide, for example. The layered metal oxide is represented by a formula (1), for example.

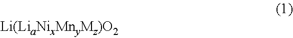

In the formula (1), −0.1≤a≤0.1, 0.7≤x≤1.0, 0≤y≤0.3, 0≤z≤0.3, and a+x+y+z=1 are satisfied. M denotes at least one selected from the group consisting of Co, Al, Zr, B, Mg, Fe, Cu, Zn, Sn, Na, K, Ba, Sr, Ca, W, Mo, Nb, Ti, Si, V, Cr, and Ge.

Aggregated particle 14 and single particle 16 may independently include at least one selected from the group consisting of LiNi_{0.8}Co_{0.1}Mn_{0.1}O₂, LiNi_{0.7}Co_{0.2}Mn_{0.1}O₂, LiNi_{0.7}Co_{0.1}Mn_{0.2}O₂, LiNi_{0.6}Co_{0.3}Mn_{0.1}O₂, LiNi_{0.6}Co_{0.2}Mn_{0.2}O₂, and LiNi_{0.6}Co_{0.1}Mn_{0.3}O₂, for example.

Aggregated particle 14 and single particle 16 may independently include at least one selected from the group consisting of LiNi_{0.8}Co_{0.1}Mn_{0.1}O₂, LiNi_{0.7}Co_{0.2}Mn_{0.1}O₂, and LiNi_{0.6}Co_{0.2}Mn_{0.2}O₂, for example.

Both aggregated particle 14 and single particle 16 may include LiNi_{0.8}CO_{0.1}Mn_{0.1}O₂, for example.

Each of first active material layer 13 and second active material layer 15 may further include an additional component in addition to the positive electrode active material. First active material layer 13 and second active material layer 15 may independently include a conductive material, a binder, and the like, for example. The conductive material may include any component. The conductive material may include at least one selected from the group consisting of carbon black, graphite, vapor grown carbon fibers (VGCFs), carbon nanotubes (CNTs), and graphene flakes, for example. The amount of the conductive material to be used may be, for example, from 0.1 parts by mass to 10 parts by mass relative to 100 parts by mass of the positive electrode active material. The binder may include any component. The binder may include at least one selected from the group consisting of polyvinylidene difluoride (PVdF), poly(vinylidenefluoride-co-hexafluoropropylene) (PVdF-HFP), polytetrafluoroethylene (PTFE), and polyacrylic acid (PAA), for example. The amount of the binder to be used may be, for example, from 0.1 parts by mass to 10 parts by mass relative to 100 parts by mass of the positive electrode active material.

From the viewpoint of input-output resistance, the mass ratio of second active material layer 15 to first active material layer 13 in positive electrode active material layer 12 ((the mass of the first active material layer)/(the mass of the second active material layer)) is preferably from 1/9 to 3/7, more preferably not less than 1/9 and less than 3/7, further preferably from 1/9 to 2/8.

First active material layer 13 has a depressed structure in which a plurality of depressions are formed on a side facing the second active material layer 15. In FIG. 1, each depression is illustrated as a region F where no aggregated particles 14 are present.

Second active material layer 15 has a protruded structure in which a plurality of protrusions are formed on a side facing the first active material layer 13. In FIG. 1, each protrusion is illustrated as region F where single particles 16 are present.

A combination of the depressions of first active material layer 13 and the protrusions of second active material layer 15 forms an uneven interface shape. At a depression of first active material layer 13, single particles 16 in a protrusion of second active material layer 15 with relatively high resistance are surrounded by aggregated particles 14 with relatively low resistance, and, as a result, electrical connection is improved and thereby input-output resistance tends to be reduced. When positive electrode plate 10 is a belt-shaped sheet or an oblong sheet, the positive electrode active material layer may have an uneven interface shape in a direction parallel to the long-side direction, or it may have an uneven interface shape in a direction parallel to the short-side direction, or it may have an uneven interface shape in both directions.

The cross-sectional shape of each depression and each protrusion (for example, the shape of region F) may be rectangular, semicircular, semielliptical, triangular, trapezoidal, and/or the like, for example. The uneven interface shape is formed by a combination of the depressions positioned at a regular interval and the protrusions positioned at a regular interval.

In a plan view of positive electrode plate 10, the depressions and the protrusions may be positioned with regularity, and the pattern may be, for example, a pattern where one, two, or more linear depressions and one, two, or more linear protrusions are positioned in a direction parallel to either the long-side direction or the short-side direction (stripes), or a pattern where one, two, or more linear depressions cross one, two, or more linear protrusions in the long-side direction and in the short-side direction (a grid), or a pattern where point-like depressions and point-like protrusions are positioned with regularity (dots). The type of the pattern for the depressions and the protrusions may correspond to the type of the pattern of an uneven-shaped die with depressions and protrusions that is used for forming the first active material layer as described below.

When the depressions and the protrusions are positioned in stripes in a plan view of positive electrode plate 10, they may be positioned in a direction parallel to either the long-side direction or the short-side direction of positive electrode plate 10. When the depressions and the protrusions are positioned in stripes in a plan view of positive electrode plate 10, the interface shape in a direction vertical to the stripes can be uneven.

When the depressions and the protrusions are positioned in a grid in a plan view of positive electrode plate 10, the interface shape of a straight line connecting the centers of adjacent squares can be uneven.

When the depressions and the protrusions are positioned in dots in a plan view of positive electrode plate 10, the interface shape of a straight line connecting the centers of adjacent dots can be uneven. In a plan view of positive electrode plate 10, the shape of the dots may be rectangular (square, oblong, diamond, and/or the like), circular, elliptical, and/or the like, for example. When the depressions and the protrusions are positioned in dots in a plan view of positive electrode plate 10, the three-dimensional shape of the protrusions and the depressions may be a rectangular parallelepiped, a cube, a cylinder, a cone, a frustum of a cone, a quadrangular pyramid, a frustum of a quadrangular pyramid, and/or the like, for example.

In a cross section in the thickness direction of the positive electrode active material layer, when the depth of the depressions (the dimension in the thickness direction of positive electrode active material layer 12) is defined as C and the thickness of the second active material layer on a part of the first active material layer without the depressions (the dimension in the thickness direction of positive electrode active material layer 12) is defined as D, the ratio of C to D (C/D) (hereinafter also called a first ratio) can satisfy an expression (1) below, for example.

$$C / D \leq 3.0 \qquad ( 1 )$$

The upper limit to the first ratio is preferably 2 or less from the viewpoint of input-output resistance, and the lower limit to the first ratio may be 0.3 or more, or 0.5 or more, for example. When the first ratio is within the above range, the distance between single particles 16 in region F and the liquid level (C+D) falls within a proper range, and thereby, resistance of second active material layer 15 tends to be reduced and input-output resistance tends to be reduced.

In a cross section in the thickness direction of the positive electrode active material layer, when the thickness of the positive electrode active material layer is defined as T, the depth of the depressions (the dimension in the thickness direction of positive electrode active material layer 12) is defined as C, and the thickness of the second active material layer on a part of the first active material layer without the depressions (the dimension in the thickness direction of positive electrode active material layer 12) is defined as D (hereinafter also called a dimension D), the ratio of the total of C and D to T [(C+D)/T] (hereinafter also called a second ratio) can satisfy an expression (2) below, for example.

$$( C + D ) / T < 0.5 \qquad ( 2 )$$

From the viewpoint of input-output resistance, the upper limit to the second ratio is preferably 0.4 or less. The lower limit to the second ratio may be 0.1 or more, for example. When the second ratio is within the above range, the distance between second active material layer 15 and the liquid level falls within a proper range, and thereby input-output resistance tends to be reduced.

In a cross section in the thickness direction of the positive electrode active material layer, when the width of the protrusions [the dimension in the planar direction of positive electrode active material layer 12 (a direction vertical to the thickness direction)] is defined as A and the distance between the protrusions [the dimension in the planar direction of positive electrode active material layer 12 (a direction vertical to the thickness direction)] is defined as B, the ratio of B to A (B/A) (hereinafter also called a third ratio) can satisfy an expression (3) below, for example.

$$2 \leq B / A \qquad ( 3 )$$

From the viewpoint of input-output resistance, the upper limit to the third ratio is preferably 16 or less, more preferably 5 or less. When the third ratio is within the above range, a proper amount of aggregated particles 14 tends to be positioned in the gaps between the protrusions, and thereby a sufficient electrical connection for single particles 16 in region F can be ensured, and, as a result, input-output resistance tends to be reduced.

In a cross section in the thickness direction of the positive electrode active material layer, when the width of the protrusions is defined as A and the average particle size of the single particles is defined as R₂, the ratio of A to R₂ (A/R₂) (hereinafter also called a fourth ratio) can satisfy an expression (4) below.

$$A / {R}_{2} \leq 6. \qquad ( 4 )$$

From the viewpoint of input-output resistance, the lower limit to the fourth ratio is preferably 2.0 or more. When the fourth ratio is within the above range, the protrusions tend to be filled with a proper amount of single particles 16, and thereby electrical connection for single particles 16 inside the protrusions tends to be ensured, so input-output resistance tends to be reduced.

Each of the thickness T of positive electrode active material layer 12, the depth C of the depressions, the thickness D of the second active material layer on a part of the first active material layer without the depressions, the width A of the protrusions, and the distance B between the protrusions is measured by a method described below in the Examples section.

It is possible to satisfy the first to fourth ratios by regulating the rolling conditions for first active material layer 13 and second active material layer 15 and the weight thereof per unit area, selecting the types of aggregated particles 14 and single particles 16, and the like, for example.

Positive electrode plate 10 can be prepared by the procedure described below, for example. Firstly, a positive electrode composite material slurry for forming a first active material layer (hereinafter also called a first slurry) is applied to a positive electrode current collector, and dried. Then, a specific uneven-shaped die is prepared, and rolling is performed with the die interposed between the press rolls of a roll press, to form a depressed structure in which a plurality of depressions are formed on the surface of the first active material layer. Subsequently, a positive electrode composite material slurry for forming a second active material layer (hereinafter also called a second slurry) is applied to the first active material layer in a certain mass ratio, and thereby the second slurry enters into the depressions formed in the first active material layer. After drying, the first active material layer and the second active material layer formed on the surface of the positive electrode current collector are rolled to a certain thickness, to make the protrusions of the second active material layer engage into the depressions formed in the first active material layer, and thereby a positive electrode active material layer having an uneven interface shape is formed, and thus positive electrode plate 10 is produced. The positive electrode composite material slurry may include a conductive material, a binder, a solvent, and the like, for example, in addition to the positive electrode active material. The pattern of the uneven-shaped die may have a stripe pattern, a grid pattern, a dot pattern, and/or the like, for example.

### <Non-Aqueous Electrolyte Secondary Battery>

A battery according to the present disclosure (hereinafter also called the present battery) has a positive electrode plate, and it includes the above-described positive electrode plate. As a result, output resistance tends to be reduced.

Usually, the present battery includes an electrode assembly that includes a positive electrode, as well as a non-aqueous electrolyte solution. The present battery may have a battery case for accommodating the electrode assembly and the non-aqueous electrolyte solution. The battery case can include an exterior package having an opening, and a sealing plate for sealing the opening. Each of the exterior package and the sealing plate can be formed by using a metal such as, for example, Al, Al alloy, iron, or iron alloy, and, for example, it can be formed by using an Al-laminated film. Between the electrode assembly and the exterior package, a resin sheet may be provided as an electrode holder.

The electrode assembly may include the above-described positive electrode plate, a negative electrode plate, and a separator. In the electrode assembly, an active material layer of the positive electrode plate faces a negative electrode active material layer of the negative electrode plate, with the separator interposed therebetween. The electrode assembly may be a stack-type one that is formed by stacking the positive electrode plate, the negative electrode plate, and the separator, or may be a wound-type one that is formed by stacking the positive electrode plate, the negative electrode plate, and the separator and winding the resulting stack.

Usually, the negative electrode plate has a negative electrode current collector, as well as a negative electrode active material layer that is formed on one side or both sides of the negative electrode current collector. The negative electrode current collector is a metal foil sheet that is made by using a copper material such as copper and copper alloy, for example. The negative electrode active material layer includes a negative electrode active material, and it may further include a conductive material, a binder, and the like.

The negative electrode active material may be a known material, and examples thereof include carbon-based active material particles such as graphite, metal-based active material particles that include an element selected from the group consisting of Si, Sn, Sb, Bi, Ti, and Ge, and the like. Examples of the conductive material include those mentioned above. Examples of the binder include cellulose-based resins such as CMC, methylcellulose (MC), and hydroxypropylcellulose; polyacrylic acid; styrene-butadiene rubber (SBR); and the like. CMC may also be used as a thickener.

The separator has a monolayered or multilayered base material, and on at least one side of the base material, it may have a functional layer. The base material may be a porous sheet such as a film and/or a nonwoven fabric, which is made of a resin such as polyolefin (such as polyethylene and polypropylene), polyester, cellulose, polyamide, and/or the like. The functional layer may be an adhesive layer and/or a heat-resistant layer, for example. The adhesive layer can be formed with an adhesive agent, for example. The heat-resistant layer can include a filler and a binder, for example.

The non-aqueous electrolyte solution is preferably obtained by adding an electrolyte to a non-aqueous solvent such as an organic solvent. Examples of the electrolyte include one or more from LiPF₆, LiBF₄, LiClO₄, LiFSO₃, LiBOB, and the like. Examples of the non-aqueous solvent include one or more from ethylene carbonate (EC), ethyl methyl carbonate (EMC), dimethyl carbonate (DMC), propylene carbonate (PC), butylene carbonate (BC), diethyl carbonate (DEC), and the like. The non-aqueous electrolyte solution may further include an additive such as vinylene carbonate (VC), vinylethylene carbonate (VEC), and/or fluoroethylene carbonate.

In the following, the present invention will be described in further detail by way of Examples.

### EXAMPLES

### [Evaluation of Input-Output Resistance]

### (Preparation of Non-Aqueous Electrolyte Secondary Battery)

A positive electrode plate and a graphite negative electrode prepared in Examples and Comparative Examples were cut into certain dimensions. They were stacked together, with a double-layer separator composed of polyethylene and a heat-resistant layer interposed therebetween, in such a manner that the heat-resistant layer and a positive electrode active material layer came into contact with each other and an aluminum foil sheet of a positive electrode current collector was exposed, to prepare an electrode assembly. The aluminum foil sheet of the positive electrode current collector and an aluminum plate for external current collection were welded together, and the graphite negative electrode and a copper plate for external current collection were welded together, and then the resultants were inserted into an exterior package made of an aluminum laminated film and fused. An electrolyte solution containing LiPF₆ at 1.15 mol/L in EC+EMC+DMC (3:3:4 in volume ratio) was injected thereinto, and the laminated film was sealed, followed by leaving the resultant to stand for 12 hours to produce a non-aqueous electrolyte secondary battery.

### (Measurement of Input-Output Resistance)

In an environment at a temperature of −10° C., the non-aqueous electrolyte secondary battery (including graphite as the counter electrode) was charged at 0.5° C. to reach a state of charge (SOC) of 50%. After completion of the charging and then 15 minutes of resting, discharging was carried out at 0.1 C for 10 seconds. The voltage at 0.1 seconds and 10 seconds after the start of discharging was recorded together with the value of current for discharging, followed by charging at 0.1 C for 10 seconds, during which the voltage at 0.1 seconds and 10 seconds after the start of charging was recorded together with the value of current for charging. The same procedure was carried out with the current rate changed to 0.33 C, 0.5 C, 1 C, and 1.5 C. From the relationship between the voltage at 0.1 seconds (and also the voltage at 10 seconds) after the start of discharging (charging) and the value of current, the discharge (charge) resistance for the time period from 0.1 seconds to 10 seconds after the start of discharging (charging) was calculated.

[Measurement of Average Particle Sizes R₁ and R₂]

A positive electrode active material that was freely selected was dispersed in about 1 g of water to prepare a measurement sample. The resulting measurement sample was introduced into a particle size distribution measurement apparatus (manufactured by MicrotracBEL Corp.; a laser-diffraction particle size distribution analyzer “MT3000II”) to obtain volume-based particle size distribution. The particle size in the volume-based particle size distribution at which cumulative frequency of particle sizes accumulated from the small size side reached 50% was defined as D50. The particle size D50 of aggregated particles was defined as an average particle size R₁, and the particle size D50 of single particles was defined as an average particle size R₂.

### [Measurement of Thickness T of Positive Electrode Active Material Layer, Width A and Distance B of Protrusions, Depth C and Dimension D of Depressions]

Cross sections in the thickness direction of the positive electrode active material layer were examined with a scanning electron microscope (SEM), and thereby cross-sectional SEM images were captured. Ten cross-sectional SEM images were thus captured each for a cross section at a randomly-selected position of the positive electrode active material layer, and in each image, the thickness T of the positive electrode active material layer, the width A of the protrusion, the distance B between the protrusions, and the depth C and the dimension D of the depression were measured, and the average value was determined. Each of the thickness T, the width A of the protrusion, and the depth C and the dimension D of the depression was measured at a position in each cross-sectional SEM image where the greatest value was obtained. The distance B between the protrusions was measured at a position in each cross-sectional SEM image where the smallest value was obtained.

### Example 1

100 parts by mass of a first active material [aggregated particles, with a D50 (R₁) of 10.2 μm], 1.5 parts by mass of a conductive material (graphite), 1 part by mass of a binder (PVdF powder), and a proper amount of dispersion medium (N-methyl-2-pyrrolidone) were mixed together to prepare a first slurry. 100 parts by mass of a second active material [single particles, with a D50 (R₂) of 3.9 μm], 1.5 parts by mass of a conductive material (graphite), 1 part by mass of a binder (PVdF powder), and a proper amount of dispersion medium (N-methyl-2-pyrrolidone) were mixed together to prepare a second slurry. The composition of both the first active material and the second active material was LiNi_{0.8}Co_{0.1}Mn_{0.1}O₂.

The first slurry was applied to the surface of a positive electrode current collector (an Al foil sheet) that was oblong in a plan view, and dried, to prepare a first active material layer. A specific uneven-shaped die was prepared, and rolling was performed with the die interposed between the press rolls of a roll press, to form a depressed structure in which a plurality of depressions were formed in the surface of the first active material layer in stripes in a direction parallel to the long-side direction. The uneven-shaped die had a pattern in which depressions with oblong cross-sectional shapes were positioned in stripes in such a manner that, in a cross section of the positive electrode active material layer, the width A of the protrusions was 10 μm (about 2.5 times greater than R₂), the distance B between the protrusions was 20 μm, and the depth C of the depressions was 0.075 times the entire thickness T of the positive electrode active material layer. Subsequently, the second slurry was applied to the surface of the first active material layer, and dried, and thereby a second active material layer was prepared. The weight of the second active material layer per unit area was adjusted to become 1/9 of the weight of the first active material layer per unit area. The first active material layer and the second active material layer formed on the surface of the base material were rolled to a certain thickness, and thereby a positive electrode plate was produced. The rolling conditions for the first active material layer and the second active material layer were regulated so that the first ratio (C/D) became 1.0, the second ratio [(C+D)/T] became 0.15, the third ratio (B/A) became 2, and the fourth ratio (A/R₂) became 2.5. The second active material layer had a protruded structure in which a plurality of protrusions were formed on a side facing the first active material layer. In a cross section in the short-side direction of the positive electrode active material layer, the interface had an uneven shape formed by a combination of the protrusions of the first active material layer and the depressions of the second active material layer. Results are given in Table 1.

### Examples 2 to 7

Positive electrode plates were prepared in the same manner as in Example 1 except that the rolling conditions for the first active material layer and the second active material layer were regulated so as to achieve the first to fourth ratios specified in Table 1. In Examples 2 to 7, the interface had an uneven shape formed by a combination of the protrusions of the first active material layer and the depressions of the second active material layer. Results are given in Table 1.

### Comparative Example 1

A positive electrode plate was prepared in the same manner as in Example 1 except that the depressed structure of the first active material layer was not formed and the protruded structure of the second active material layer was not formed. Results are given in Table 1.

TABLE 1

| | | Mass | | | | | |
|---|---|---|---|---|---|---|---|
| | | ratio | | | | | |
| | | (Second | | | | | |
| | | active | | | | | |
| | | material | | | | | |
| | | layer)/ | | | | | |
| | | (First | | Second | | | Input- |
| | | active | First | ratio | Third | Fourth | output |
| | Uneven | material | ratio | [(C + | ratio | ratio | resistance |
| | shape | layer) | (C/D) | D)/T] | (B/A) | (A/R₂) | (mΩ) |
| Ex. 1 | Yes | 1/9 | 1.0 | 0.15 | 2 | 2.5 | 427.3 |
| Ex. 2 | Yes | 1/9 | 2.0 | 0.23 | 5 | 2.5 | 438.1 |
| Ex. 3 | Yes | 1/9 | 0.3 | 0.14 | 2 | 2.5 | 447.9 |
| Ex. 4 | Yes | 1/9 | 3.0 | 0.20 | 1 | 2.5 | 470.0 |
| Ex. 5 | Yes | 1/9 | 1.0 | 0.15 | 2 | 1.5 | 443.7 |
| Ex. 6 | Yes | 1/9 | 1.0 | 0.15 | 2 | 7.5 | 460.0 |
| Ex. 7 | Yes | 1/9 | 5.7 | 0.50 | 16 | 2.5 | 475.3 |
| Comp. | No | 1/9 | — | — | — | — | 481.0 |
| Ex. 1 | | | | | | | |

### Example 8

A positive electrode plate was prepared in the same manner as in Example 1 except that the mass ratio of the second active material layer to the first active material layer was made to be the mass ratio specified in Table 2, and the rolling conditions for the first active material layer and the second active material layer were regulated so as to achieve the first to fourth ratios specified in Table 2. The interface had an uneven shape formed by a combination of the protrusions of the first active material layer and the depressions of the second active material layer. Results are given in Table 2.

### Comparative Example 2

A positive electrode plate was prepared in the same manner as in Example 1 except that the mass ratio of the second active material layer to the first active material layer was made to be the mass ratio specified in Table 2, the depressed structure of the first active material layer was not formed, and the protruded structure of the second active material layer was not formed. Results are given in Table 2.

TABLE 2

| | | Mass | | | | | |
|---|---|---|---|---|---|---|---|
| | | ratio | | | | | |
| | | (Second | | | | | |
| | | active | | | | | |
| | | material | | | | | |
| | | layer)/ | | | | | |
| | | (First | | Second | | | Input- |
| | | active | First | ratio | Third | Fourth | output |
| | Uneven | material | ratio | [(C + | ratio | ratio | resistance |
| | shape | layer) | (C/D) | D)/T] | (B/A) | (A/R₂) | (mΩ) |
| Ex. 8 | Yes | 3/7 | 1.0 | 0.45 | 2 | 2.5 | 505.6 |
| Comp. | No | 3/7 | — | — | — | — | 532.2 |
| Ex. 2 | | | | | | | |

### Comparative Example 3

A positive electrode plate was prepared in the same manner as in Example 1 except that the mass ratio of the second active material layer to the first active material layer was made to be the mass ratio specified in Table 3, and the rolling conditions for the first active material layer and the second active material layer were regulated so as to achieve the first to fourth ratios specified in Table 3. The interface had an uneven shape formed by a combination of the protrusions of the first active material layer and the depressions of the second active material layer. Results are given in Table 3.

### Comparative Example 4

A positive electrode plate was prepared in the same manner as in Example 1 except that the mass ratio of the second active material layer to the first active material layer was made to be the mass ratio specified in Table 3, the depressed structure of the first active material layer was not formed, and the protruded structure of the second active material layer was not formed. Results are given in Table 3.

TABLE 3

| | | Mass | | | | | |
|---|---|---|---|---|---|---|---|
| | | ratio | | | | | |
| | | (Second | | | | | |
| | | active | | | | | |
| | | material | | | | | |
| | | layer)/ | | | | | |
| | | (First | | Second | | | Input- |
| | | active | First | ratio | Third | Fourth | output |
| | Uneven | material | ratio | [(C + | ratio | ratio | resistance |
| | shape | layer) | (C/D) | D)/T] | (B/A) | (A/R₂) | (mΩ) |
| Comp. | Yes | 4/6 | 1.0 | 0.6 | 2 | 2.5 | 585.3 |
| Ex. 3 | | | | | | | |
| Comp. | No | 4/6 | — | — | — | — | 575.7 |
| Ex. 4 | | | | | | | |

In Examples 1 to 7 in which the interface shape of the positive electrode active material layer was uneven, the input-output resistance was reduced as compared to Comparative Example 1 in which the interface shape of the positive electrode active material layer was not uneven. Moreover, in Example 8 in which the interface shape of the positive electrode active material layer was uneven, the input-output resistance was reduced as compared to Comparative Example 2 in which the interface shape of the positive electrode active material layer was not uneven. In contrast, in Comparative Example 3 in which the interface shape of the positive electrode active material layer was uneven but the mass ratio of the second active material layer was high, degradation of resistance against diffusion due to the large distance between the second active material layer and the liquid level affected greatly, and input-output resistance was not reduced as compared to Comparative Example 4 in which the interface shape of the positive electrode active material layer was not uneven.

Although the embodiments of the present invention have been described, the embodiments disclosed herein are illustrative and non-restrictive in any respect. The scope of the present invention is defined by the terms of the claims, and is intended to encompass any modifications within the meaning and the scope equivalent to the terms of the claims.

What is claimed is:

1. A positive electrode plate comprising:
a positive electrode current collector; and
a positive electrode active material layer provided on the positive electrode current collector, wherein
the positive electrode active material layer includes a first active material layer and a second active material layer,
the first active material layer is positioned closer to the positive electrode current collector,
the second active material layer is positioned in contact with the first active material layer and on a side of the first active material layer opposite to the positive electrode current collector,
the first active material layer includes secondary particles each consisting of primary particles aggregated together,
the second active material layer includes single particles,
the first active material layer has a depressed structure in which a plurality of depressions are formed on a side facing the second active material layer,
the second active material layer has a protruded structure in which a plurality of protrusions are formed on a side facing the first active material layer,
in a cross section in a thickness direction of the positive electrode active material layer passing through the plurality of depressions and the plurality of protrusions, an interface at which the first active material layer and the second active material layer are in contact with each other has an uneven shape formed by a combination of the plurality of depressions and the plurality of protrusions, and
a mass ratio of the second active material layer to the first active material layer in the positive electrode active material layer is from 1/9 to 3/7.

2. The positive electrode plate according to claim 1, wherein a ratio of C to D (C/D) satisfies an expression (1) below:
$$C / D \leq 3.0 \qquad ( 1 )$$
where a depth of the depressions is defined as C, and a thickness of the second active material layer on a part of the first active material layer without the depressions is defined as D.

3. The positive electrode plate according to claim 1, wherein a ratio of a total of C and D to T [(C+D)/T] satisfies an expression (2) below:
$$( C + D ) / T < 0.5 \qquad ( 2 )$$
where a thickness of the positive electrode active material layer is defined as T, a depth of the depressions is defined as C, and a thickness of the second active material layer on a part of the first active material layer without the depressions is defined as D.

4. The positive electrode plate according to claim 1, wherein a ratio of B to A (B/A) satisfies an expression (3) below:
$$2 \leq B / A \qquad ( 3 )$$
where a width of the protrusions is defined as A, and a distance between the protrusions is defined as B.

5. The positive electrode plate according to claim 1, wherein a ratio of A to R₂ (A/R₂) satisfies an expression (4) below:
$$A / {R}_{2} \leq 6. \qquad ( 4 )$$
where a width of the protrusions is defined as A, and an average particle size of the single particles is defined as R₂.

6. A non-aqueous electrolyte secondary battery comprising the positive electrode plate according to claim 1.
